(19) United States
(12) Patent Application Publication
(10) Pub. No.: US 2006/0176686 A1
(43) Pub. Date: Aug. 10, 2006

(54) Submersible lighting device

(76) Inventor: Brian D. McVicker, Beecher, IL (US)

Correspondence Address: Daniel N. Christus, Esq.;Wallenstein Wagner & Rockey, Ltd., 53rd Floor, 311 South Wacker Drive, Chicago, IL, 60606-6630, US

(21) Appl. No.: 11/349,679

(22) Filed: Feb. 8, 2006

Related U.S. Application Data
(60) Provisional application No. 60/651,782, filed on Feb. 9, 2005.
(60) Provisional application No. 60/681,709, filed on May 18, 2005.

(51) Int. Cl. F21L 4/00; F21L 13/00

(52) U.S. Cl. 362/183

(57) ABSTRACT

The invention is a submersible lighting device, having a substantially water-tight enclosure, and a plurality of lighting elements at the top of that enclosure. A beam of light projecting from at least some of the lighting elements is upwardly disposed from that lighting device, at an angle from the vertical.

### CROSS-REFERENCE TO RELATED APPLICATIONS

This application claims priority from, and the benefit of, co-pending provisional Application No. 60/651,782, filed on Feb. 9, 2005, and co-pending provisional Application No. 60/681,709, filed on May 18, 2005, which applications are incorporated herein by reference and made a part hereof.

### FEDERALLY SPONSORED RESEARCH OR DEVELOPMENT

Not applicable.

### TECHNICAL FIELD

The present invention generally relates to lighting devices, and more specifically to a lighting device used in underwater applications.

### BACKGROUND OF THE INVENTION

Underwater lighting devices are known in the art. These and other generally relevant devices are shown in various United States Patents, including U.S. Pat. Nos. 1,745,901; 2,051,175; 2,779,866; 3,005,908; 3,502,861; 4,187,533; 4,190,976; 4,429,350; 4,598,346; 4,661,893; 4,779, 174; 4,947,304; 6,315,429; 6,379,025; 6,669,352; and U.S. Patent Application Publication Nos. US 2002/0178641 and US 2003/0026097.

U.S. Pat. No. 1,745,901 is directed to an underwater lighting unit in which an incandescent electric lamp includes a bulb immersed in direct contact with the water.

U.S. Pat. No. 2,051,175 is directed to a submersible lighting fixture that enables the replacement of its incandescent lamps, all without removing the lighting fixture from the body of water in which it is submersed.

U.S. Pat. Nos. 2,779,866, 3,005,908, and 3,502,861 are all underwater lights designed primarily for fishing. The Figures of the '866 and '908 patents depict a lamp which illuminate primarily in a downward direction, while the Figures of the '861 patent show the axis of the lamp oriented horizontally.

U.S. Pat. Nos. 4,187,533, 4,190,976, and 4,598,346 are also directed to submersible fishing lights. The '533 patent includes lamps which project upwardly with a relatively narrow vertical beam above and below the level of the fixture in the water. The '976 patent is directed to a device which is said to produce both light and a fish-attracting sound. The incandescent bulbs of the '346 patent direct light in a generally vertically downward direction.

U.S. Pat. No. 4,429,350 is directed to a subsurface light having an elongated, adjustable handle, and flotation means.

U.S. Pat. No. 4,661,893 is directed to an underwater lighting fixture for illuminating an object that is above the surface of the water, and including baffles for directing the light beams.

U.S. Pat. No. 4,779,174 is directed to a submersible lighting device that includes a dome-like top. Nevertheless, the light-emitting lamps in this device are not attached to this dome-like top. The device of the '174 patent is similar to those of U.S. Pat. Nos. 6,669,352, 6,315,429, and U.S. Patent Application Publication No. US 2002/0178641, in that the lamps in all of these devices direct light upwardly, in a generally vertical direction.

U.S. Pat. No. 4.947,304 is directed to an underwater lighting apparatus with a lamp having a filament, an envelope surrounding the filament, and a pair of contacts extending through the envelope.

U.S. Pat. No. 6,379,025 is directed to a light for a swimming pool, and including a motor-driven light wheel.

Finally, U.S. Patent Application Publication No. 2003/0026097 is directed to a light fixture with a submersible enclosure for an electric lamp, and in which the light is projected in a generally horizontal direction.

Such underwater lighting devices are generally suitable for their intended purposes, but each has its own limitations.

### SUMMARY OF THE INVENTION

The present invention is a sinking light device or fixture. The device can be of any acceptable shape, including but not limited to a globe or a ring shape. The sinking light device can include an internal, rechargeable battery pack that powers a plurality of spotlights or light emitting diodes (LED). The spotlights or LEDs illuminate upwardly, to create a cone-shaped or other suitably shaped region of light above the fixture. This region of light above the lighting fixture can illuminate swimmers and water above the light ring. The lighting fixture is suitable for use in a swimming pool, pond, lake, river, ocean, or other body of water.

The light ring can be deployed from a boat, and can be used, for example, to illuminate the underside of the boat, and the water around that boat. In this way, the user can inspect the boat, and illuminate the boat so as to facilitate repair.

A recharging device allows recharging of the battery pack during periods of non-use, and can further allow powering of the light device during periods of water use.

An optional lifting means at the top of the device permits tethering of the light ring off of the side of the boat. Lifting means can also be attached to bottom of the submersible device. Both of these lifting means permit the lifting of the submersible device from the body of water. Alternatively a floating light ring illuminates downwardly to illuminate the bottom of the body of water and for emergency water rescue operations.

### BRIEF DESCRIPTION OF THE DRAWINGS

FIG. 1 is a top plan view of a first embodiment of a submersible device of the present invention which sinks, and then illuminates upwardly, using a plurality of spotlights;

FIG. 2 is a lateral vertical sectional view of the submersible device taken along the line 2-2 of FIG. 1, and showing the spotlights, an internal battery pack, and a removable eye-bolt of an optional lifting device;

FIG. 3 is a perspective view of the battery pack showing a plurality of rechargeable batteries;

FIG. 4 is a lateral vertical sectional view of a recharging socket for the submersible device, taken on the line 4-4 of FIG. 1, and shown with a mating recharging plug of the recharging device, and showing in lateral vertical cross-section, a main power cord of the recharging device;

FIG. 5 is a perspective view of a wall plug with an internal transformer of the recharging device connected to the main power cord, for plugging into a conventional electrical wall outlet to recharge the battery pack, for directly powering the submersible device;

FIG. 6 is a side elevational view of the submersible lighting device, as deployed below a boat that is floating on a body of water, supported off a bottom of the body of water, and with a tether to that lighting device;

FIG. 7 is a side elevational view of the submersible lighting device, as deployed in a swimming pool, and resting on the bottom of the swimming pool;

FIG. 8 is a top plan view of a second embodiment of the submersible lighting device, which upon sinking, illuminates upwardly with a plurality of the spotlights;

FIG. 9 is a lateral, vertical sectional view of the submersible lighting device, taken along line 9-9 of FIG. 8, and showing the spotlights, the internal battery pack, and a fixed U-bolt, to allow attachment of the chain of the lifting device;

FIG. 10 is a top plan view of a third embodiment of the submersible lighting device, which floats, so as to illuminate downwardly, using a plurality of spotlights;

FIG. 11 is a lateral, vertical sectional view of the light ring taken on the line 11-11 of FIG. 10, showing the spotlights, the internal battery pack, and the fixed U-bolt to allow attachment of the chain of the lifting device;

FIG. 12 is an exploded view of the fourth, and most preferred, embodiment of the invention; and

FIG. 13 is a cross-sectional view of the embodiment of FIG. 12, but in an assembled condition.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

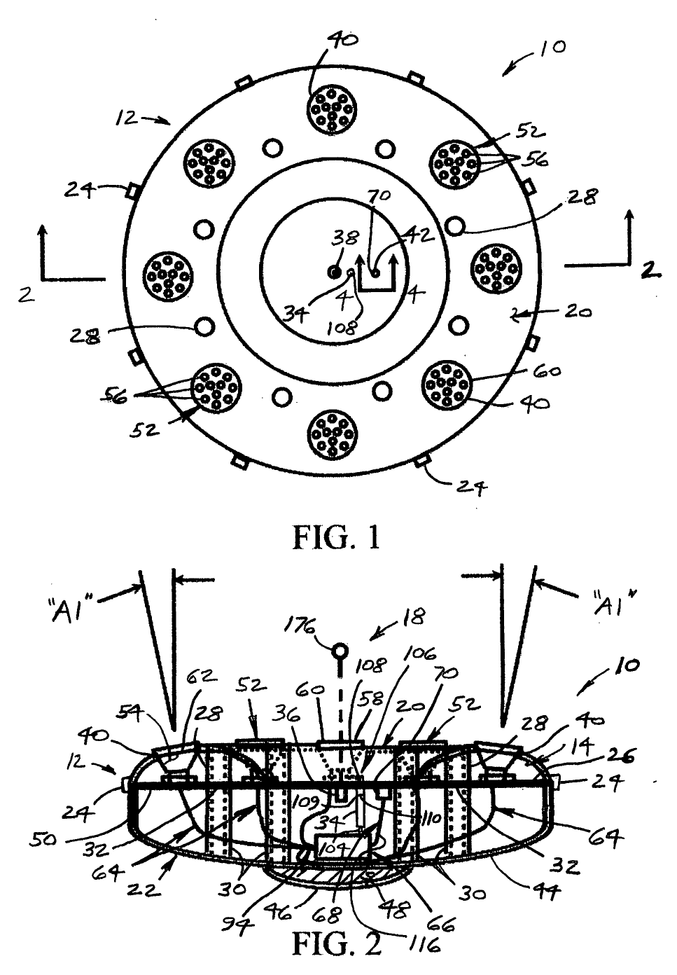

FIGS. 1 and 2 show a first embodiment of the submersible lighting fixture or device, or more specifically the light ring, of the present invention, which is designated generally at 10. The device 10 includes a two-piece housing 12 of “inverted mushroom” shape that opens to permit access to component parts inside of that device 10. The device 10 further includes an electrical lighting system 14, a recharging device 16, and an optional lifting device 18.

The housing 12 is of a generally hollowed-out disk shape, preferably of about two feet in diameter. The housing 12 includes an upper housing half 20 and a lower housing half 22. The upper housing half 20 and the lower housing half 22 are sealed by a large rubber gasket 26.

The upper housing half 20, the lower housing half 22, and the large rubber gasket 26 are retained in sealing engagement using a plurality of clamps 24. The clamps 24 may be of (a) a spring type, such as those used on mason jars, luggage, or old-style cannister vacuum cleaners; (b) a screw type; or (c) other suitable type.

A plurality of tubes 28 and 30, respectively, are integral with the upper and lower housing halves 20 and 22. Tubes 28 and 30 are connected together, using small rubber gaskets 32, which provide a seal upon the clamping together of the housing halves 20 and 22. Water may flow through these tubes 28 and 30, reducing the amount of drag upon the submersible device 10 when that device 10 is being raised or lowered.

A downwardly-extending switch actuating tube 34 is integral with the upper housing half 20. The upper housing half 20 also includes an integral center boss 36, with a molded, internally threaded metal insert 38 for attachment of the lifting device 18. A plurality of light holes 40, and a threaded electrical socket hole 42, extend through the upper housing half 20. The lower housing half 22 has a convex lower surface 44, and it includes a weight dome 46. The weight dome 46 contains lead, metal shot, or any other similar weighting material 48. The weight of the weighting materials counters the tendency of the hollow housing 12 to float.

A plurality of screws (not shown) are used to removably retain the circular light backing plate 50 and the lower housing half 22.

The lighting system 14 includes a plurality of electrical spotlights 52 that may extend through corresponding light holes 40. The spotlights 52 are preferably submersible light emitting diode (LED) lights. In the prior art, such LED lights are sold for, and used in connection with, fountain and pond lights. These LEDs are also typically powered by 12-volt direct current (D.C.) power sources. The wattage depends upon the particular operating conditions, such as the operating depth of the submersible device or light ring 10, and the clarity of the water in which the submersible light fixture 10 is submerged.

The spotlights 52 typically include an opaque housing 54, and that housing 54 generally includes a plurality of LEDs 56. A transparent lens 58 is sealingly retained to the housing 54 by a retaining ring 60. The spotlights 52 are sealingly affixed to the upper housing half 20. Those spotlights 52 extend through their corresponding light holes 40, and abut against the backing plate 50, using a plurality of screws (not shown) that extend through the retaining ring 60, sandwiched between respective rubber gaskets 62.

The spotlights 52 are available in a variety of colors, to suit the particular application, and to allow easy changing of the effective colors of those lights. As but one example, red, white, and blue colors might be desirable for a Fourth of July display.

The spotlights 52 are preferably fixed at an angle “A1” of about fifteen degrees, radially outwardly of vertical, to illuminate slightly outwardly. This illumination provides a broad “pool-like” lighting effect.

Alternatively, the spotlights 52 may be made to be movable, rather than fixed. By ensuring that these spotlights 52 are movable, light may be directed in desired directions. One or more of the spotlights 52 can flash on and off, in the manner of strobe lights. Respective power cords 64 extend from the housings 54, to a battery pack 66 suited for the spotlights 52.

A stub power cord 68 extends from the battery pack 66 to a recharging socket 70. Water can flow freely through the tubes 28 and 30, so as to provide cooling for the spotlights 52.

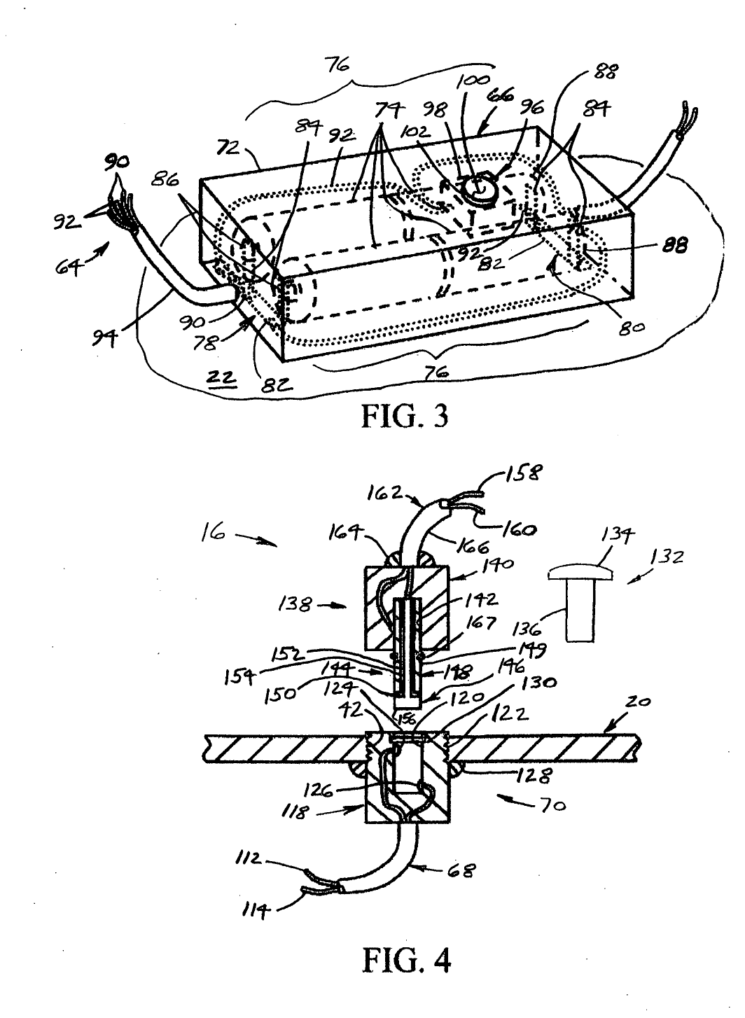

As shown in FIG. 3, the battery pack 66 includes a housing 72 affixed to the lower housing half 22. In this embodiment, the housing 72 contains four rechargeable six-volt batteries 74, preferably of a lithium, nickel-chromium, or other suitable type.

The batteries 74 are shown in two series-connected pairs 76, connected in parallel, and retained between respective positive and negative electrical contacts 78 and 80, to thereby provide twelve (12) volts to power the spotlights 52. The electrical contacts 78 and 80 each comprise a base plate 82 affixed to the housing 72 and a pair of upright plates 84 adapted to contact respective positive and negative ends 86 and 88 of the batteries 74. The power cords 64 of the spotlights 52 include respective positive and negative lead wires 90 and 92, which extend through a protective insulating sheath 94 made of cloth or plastic and into the housing 72.

The positive lead wires 90 are connected to the positive electrical contacts 78. The negative lead wires 92 are connected through a push-button type on/off switch 96 to the base plate 82 of the negative electrical contact 80. The switch 96 has a casing 98 affixed to the housing 72 and a spring-loaded push-button 100 which extends from casing 98 through a hole 102 of housing 72.

The push-button 100 is engaged by a inner end 104 of a push rod 106, slidably disposed through the switch actuating tube 34 of the upper housing half 20, with a finger-actuatable outer end 108 that extends upwardly therefrom. The inner end 104 of push rod 106 is of enlarged diameter, to prevent inadvertent removal from housing 12.

An O-ring 109 is disposed in an external groove 110 of push rod 106, to prevent water from entering the housing 12. The switch 96 allows charging of the batteries 74, without the spotlights 52 being illuminated. The negative lead wires 92 of the power cords 64 are connected to the base plate 82 of the negative electrical contact 80. The stub power cord 68 includes respective positive and negative lead wires 112 and 114, which extend through a protective insulating sheath 116 made of cloth or plastic, and into the housing 72. The positive lead wire 112 is connected to the base plate 82 of the positive electrical contact 78, and the negative lead wire 114 is connected to the base plate 82 of the negative electrical contact 80.

As shown in FIG. 4, the recharging socket 70 includes a body 118 with a central bore 120 and an externally threaded end 122 that threads into the electrical socket hole 42 of the housing half 20. A pair of positive and negative electrical contacts 124 and 126 are affixed to the body 118, extending inwardly into the central bore 120. The positive and negative lead wires 112 and 114 of the stub power cord 68 are respectively connected to the electrical contacts 124 and 126, all of which are integrally molded into the socket 70. A resilient gasket 128 made of rubber or other suitable material is affixed to the upper housing half 20 and the socket 70, to provide a waterproof seal therebetween. The body 118 has an internal O-ring groove 130, disposed within the central bore 120.

A resilient sealing plug 132 made of rubber or other suitable material includes a head 134 and dependent stem 136 which closely frictionally fits within the central bore 120 of the socket 70 during water use, to prevent water from shorting between the positive and negative electrical contacts 124 and 126.

The recharging device 16 includes a recharging plug 138 comprised of a body 140 which has a central bore 142 and an electrical contact assembly 144. The contact assembly 144 comprises a headed pin 146 and an outer tube 148 with an external O-ring groove 149, each made of an electrically conductive material, and a washer 150 and an inner tube 152, each made of an electrically insulating material. A stem 154 of the pin 146 is affixed within the inner tube 152 with the washer 150 disposed against a head thereof. The outer tube 148 is affixed disposed about the inner tube 152 abutting the washer 150, and affixed partially disposed within the central bore 142 of the body 140. Respective positive and negative lead wires 158 and 160 of a main power cord 162 of the recharging device 16 are respectively connected to the outer tube 148 and the pin 146, which are integrally molded into the body 140.

A resilient gasket 164 made of rubber or other suitable material is affixed to the body 140 and to a protective insulating sheath 166 of the main power cord 162, through which the lead wires 158 and 160 extend, and which are made of resilient rubber, plastic, or other insulating material, to provide a waterproof seal therebetween. An O-ring 167 is retained within the external O-ring groove 149 of the outer tube 148 that also removably fits within the internal O-ring groove 130 of the body 118 of recharging socket 70. This prevents water from shorting the positive and negative electrical contacts 124 and 126 during powered water use, and retains the recharging plug 138 to the recharging socket 70.

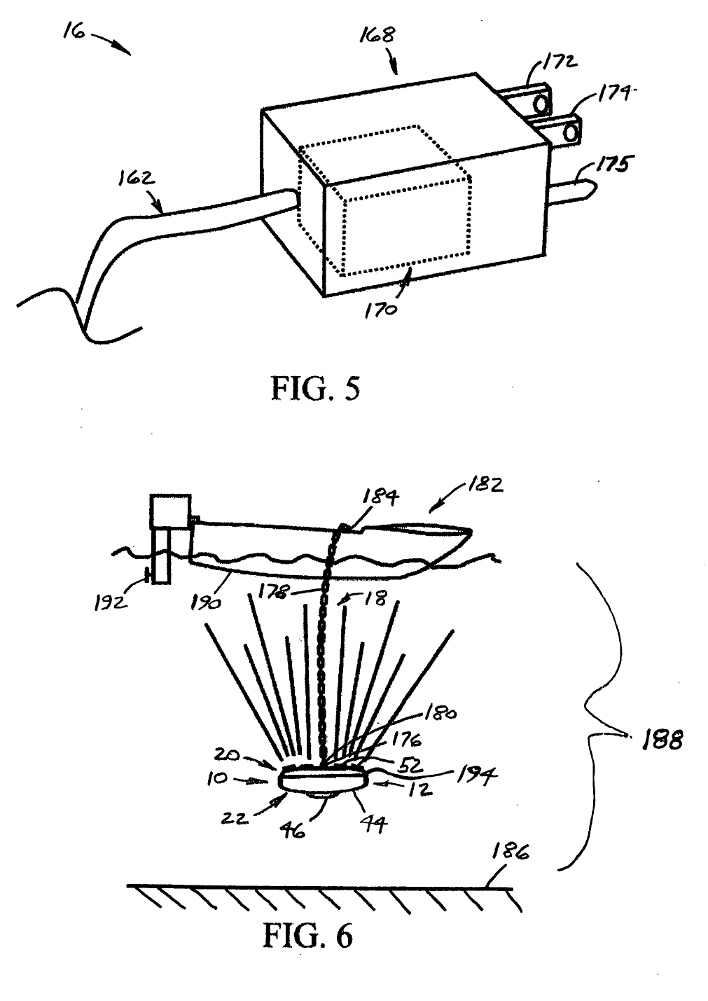

As shown in FIG. 5, the main power cord 162 terminates at a three prong grounded male wall plug 168 for plugging into a conventional grounded 110 volt electrical outlet (not shown) of a boat, dock, house, portable generator, or the like. Alternatively, a suitable two prong or other plug, battery clamp, or the like (not shown) may be used for connection to alternate power sources, such as a boat battery or the like. A transformer and rectifier assembly 170 is disposed within wall plug 168 between the main power cord 162 and respective power prongs 172 and 174 and ground prong 175 thereof. This enables conversion of the 110-volt AC current to the 12 volt direct current necessary for recharging the batteries 74, and for directly powering the spotlights 52 during water use, without presenting an electrical shock hazard.

As shown in FIGS. 1 and 6, the lifting device 18 includes a conventional eye bolt 176 that threads into the insert 38 of the center boss 36 of the upper housing half 20. A chain 178 of any suitable strength made of a corrosion resistant material such as stainless steel, plastic dipped carbon steel, painted, or the like, is attachable to the eye bolt 176 using a suitable clip 180.

As shown in FIG. 6, the light ring 10 may be suspended from a boat 182 using the eye-bolt 176, chain 178, and clip 180 from a tie-off 184 or the like, on or above a sandy, muddy, or other bottom 186 of a body of water 188, such as a lake, pond, ocean, or river, or allowed to rest thereon illuminating upwardly in a circular pattern, depending on the water depth, clarity, number and wattage of spotlights 52, and other factors.

The “inverted mushroom” shape of housing 12 with the convex lower surface 44 and weight dome 46 of lower housing half 22 allow tilting of light ring 10 on the bottom 186 of the body of water 188, by manipulating the chain 178 to direct light from spotlights 52, as desired. The light ring 10 illuminates upwardly towards a bottom 190 of the boat 182 and lights up the body of water 188 around the boat 182. This allows inspection of the bottom 190 and a propeller 192 of the boat 182 at night, so as to the illuminate the area to facilitate repairs, if necessary. If the body of water 188 is too deep for resting on the bottom 186, then it can be lowered to a desired depth, and tied-off, shown.

The light ring 10 typically weighs between about five and fifteen pounds. Weights (not shown) can be placed on the upper housing half 20, adjacent an outer periphery 194 thereof, for balance. The light ring 10 and those which follow may be used as a distress light, and may be further adapted to display distress colors, for the spotlights 52. The lighting system 14 may be modified, for example, to flash the spotlights 52 in code, such as the international “SOS”, and may be programmable to change functions, such as sequenced illuminating of the spotlights 52 for decorative effects.

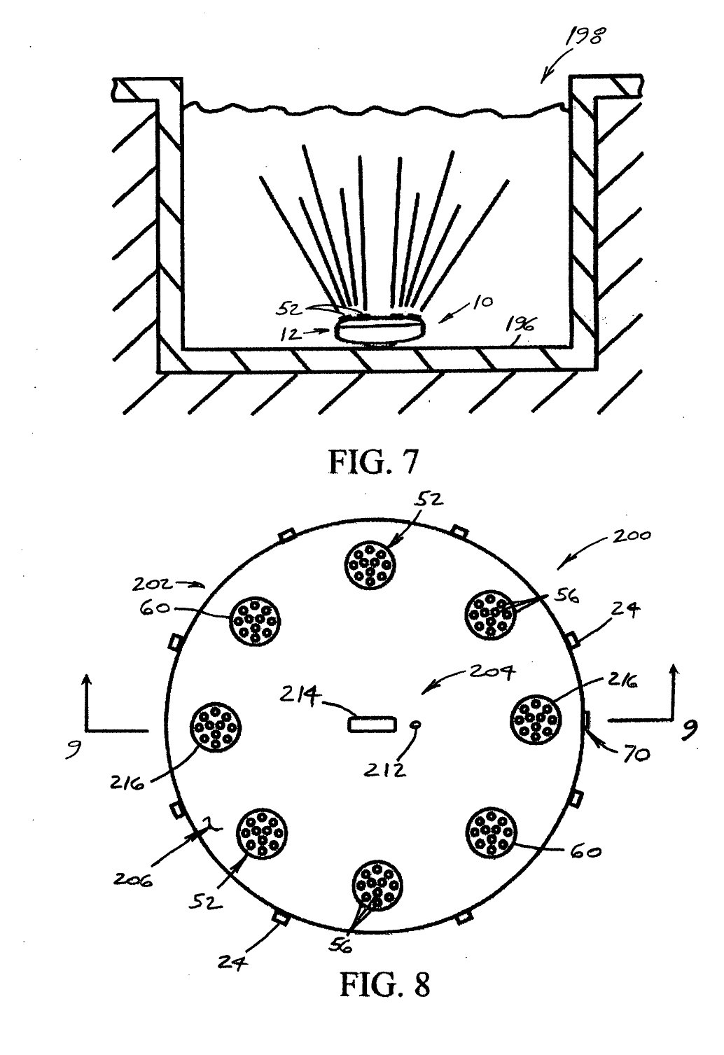

Referring to FIG. 7, the light ring 10, as well as those embodiments which follow, may be placed on a bottom 196 of an in-ground swimming pool 198, illuminating upwardly in a circular pattern on swimmers (not shown), and on the surrounding water.

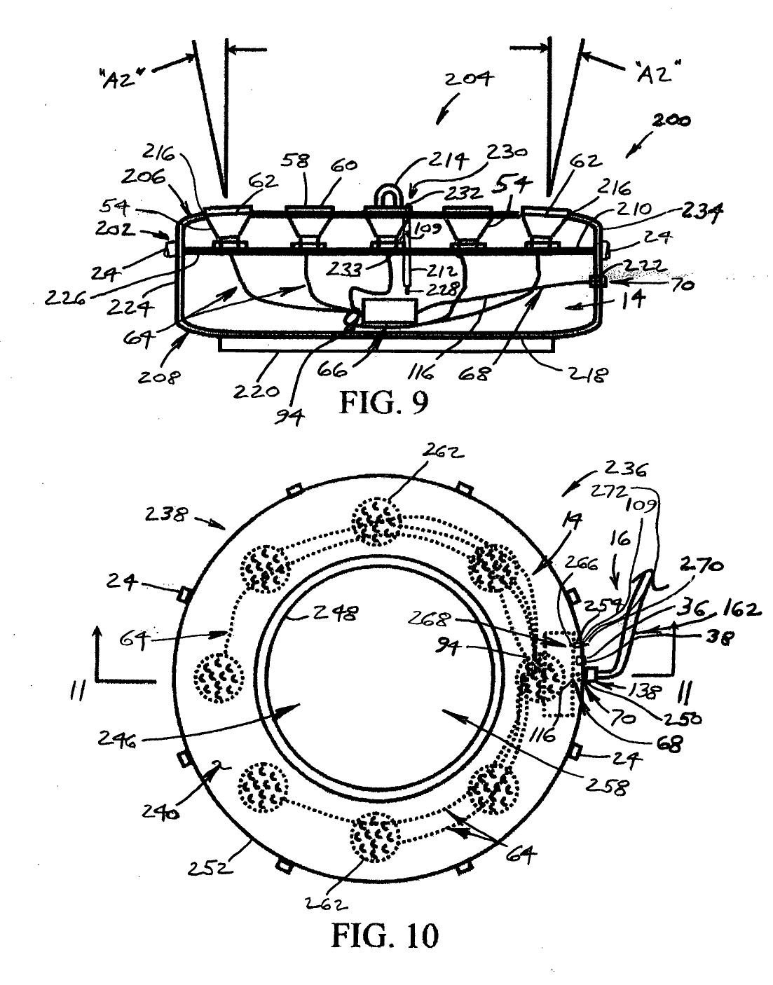

FIGS. 8 and 9 depict a second embodiment of a light ring 200, which includes a two-piece housing 202 that opens to access component parts of that housing 202. That housing 202 encloses the electrical lighting system 14, the recharging device 16, and an optional lifting device 204.

The housing 202 is of a generally hollowed disk shape, preferably about two feet in diameter, comprising an upper housing half 206 and a lower housing half 208. These two housing halves 206 and 208 are retained together in a sealing engagement, using a plurality of the clamps 24 to seal a large rubber gasket 210 between the housing halves 206 and 208.

A switch actuating tube 212 integral with the upper housing half 206 extends downwardly. The upper housing half 206 has an integral center U-bolt 214 to allow attachment of the lifting device 204. A plurality of light holes 216 extend through upper housing half 206. The lower housing half 208 has a flat lower surface 218 to which a weight disk 220 made of solid lead or other weighting material is affixed, to counter the floatation of the generally hollow housing 202. A threaded electrical socket hole 222 extends through a side wall 224 of lower housing half 206. A circular light backing plate 226 is removably retained to lower housing half 208 using a plurality of screws (not shown).

The spotlights 52 of lighting system 14 are sealingly affixed to upper housing half 206, and extend through the respective light holes 216. The spotlights abut the backing plate 226, using a plurality of screws (not shown) that extend through the retaining ring 60, with respective rubber gaskets 62 sandwiched therebetween. The spotlights 52 are preferably fixed at an angle “A2” of about fifteen degrees radially outwardly, to illuminate slightly outwardly, providing the “pool-like” lighting effect. Alternatively, the spotlights 52 may be made to be movable, so that they may direct light in desired directions. One or more of the spotlights 52 can flash on and off, in the manner of strobe lights. The power cords 64 extend from the housings 54 to the battery pack 66. The stub power cord 68 extends from the battery pack 66 to the recharging socket 70.

The battery pack 66 includes the housing 72 affixed to the lower housing half 208 which contains the rechargeable batteries 74. The lead wires 90 and 92 of the power cords 64 of the spotlights 52 extend through the insulating sheath 94 into the housing 72 connected as stated above. The push-button 100 of switch 96 is engaged by a inner end 228 of a push rod 230 slidably disposed through the switch actuating tube 212 of the upper housing half 206, with a finger-actuatable outer end 232 that extends upwardly therefrom. The inner end 228 of push rod 230 is of enlarged diameter, to prevent inadvertent removal from housing 202. The O-ring 109 is disposed in an external O-ring groove 233 of push rod 230, to prevent water from entering the housing 202. The switch 96 allows charging of the batteries 74, without the spotlights 52 being illuminated. The lead wires 112 and 114 of the stub power cord 68 extend through the insulating sheath 116 into the housing 72, and are connected as stated above.

The body 118 of the recharging socket 70 threads into the electrical socket hole 222 of the side wall 224 of lower housing half 208. The lead wires 112 and 114 of the stub power cord 68 are connected to the recharging socket 70, as explained above. The resilient gasket 128 is affixed to the side wall 224 of the lower housing half 206 and the socket 70, to provide a waterproof seat therebetween.

The sealing plug 132 includes the head 134 and dependent stem 136, which closely frictionally fits within the central bore 120 of the socket 70 during water use, to prevent water from shorting between the electrical contacts 124 and 126.

The recharging device 16 includes the recharging plug 138 for connecting to the recharging socket 70, the main power cord 162, and the wall plug 168 for plugging into the electrical outlet.

The lifting device 204 includes the U-bolt 214 of the upper housing half 206, and the chain 178 that attaches to the lifting device 204 using the clip 180.

The light ring 200 may be suspended from the boat 182 above the bottom 80 of a body of water 82, or allowed to rest thereon, illuminating upwardly in a circular pattern. This may be done using the U-bolt 214, the chain 178, and the clip 180 from the tie-off 184, as explained above. The flat lower surface 218 and weight disk 220 of lower housing half 208 do not allow significant tilting of light ring 200 on the bottom 80 of the body of water 82, and thus direct light from spotlights 52 perpendicularly to the bottom 80. The light ring 200 typically weighs between about five and fifteen pounds. Weights (not shown) can be placed on the upper housing half 206 adjacent its outer periphery 234, for balance.

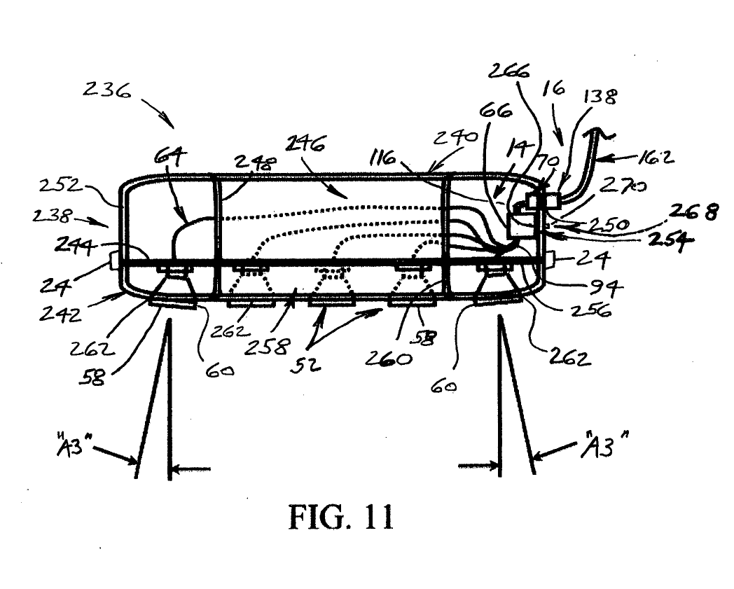

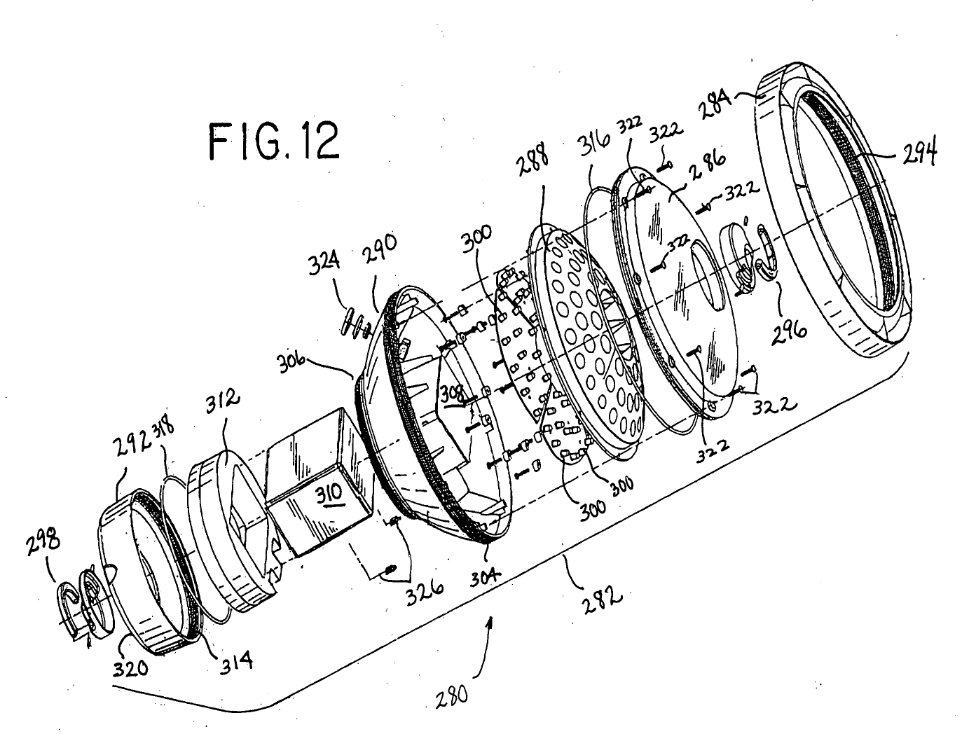

FIGS. 10 and 11 show a third embodiment of a light ring 236, which includes a two-piece housing 238 that opens to access component parts inside that housing 238, such as the electrical lighting system 14, and the recharging device 16.

The housing 238 is a generally hollow doughnut, having a life saving ring shape, preferably about two feet in diameter. Larger diameters are preferable, if the light ring 236 is used as a floatation device. This light ring 236 comprises an upper housing half 240 and a lower housing half 242 that are retained together in sealing engagement, using a plurality of clamps 24, with a large rubber gasket 244 sandwiched between the upper 240 and lower housing halves 242. The upper housing half 240 includes a center hole 246, defined by an inner side wall 248. A threaded electrical socket hole 250 extends through an outer side wall 252 of upper housing half 240. A switch actuating tube 254 integral with the upper housing half 240 extends radially inwardly. The upper housing half 240 may have the integral side boss 36 with the internally threaded metal insert 38, for attachment of the eye bolt 176 of lifting device 18, or the integral U-bolt 214 (not shown), permitting attachment of the lifting device 204. The chain 178 and clip 180 of the lifting devices 18 and 204 are attached as stated above. A circular light backing plate 256 is removably retained to upper housing half 240, using a plurality of screws (not shown). The lower housing half 242 has a center hole 258 defined by an inner side wall 260, and a plurality of light holes 262 that extend therethrough. No weights are used, since this version of the light ring 236 floats, unless additional stability is desired by attaching weights to the lower housing half 242.

The spotlights 52 of lighting system 14 are sealingly affixed to lower housing half 242 extending through corresponding light holes 262, and abutting the backing plate 264, using a plurality of screws (not shown). The screws extend through the retaining ring 60 with respective rubber gaskets 62 sandwiched therebetween. The spotlights 52 are preferably fixed at an angle “A3” of about fifteen degrees radially outwardly, to illuminate slightly outwardly, providing the “pool-like” lighting effect. Alternatively, the spotlights 52 may be made to be movable to direct light in desired directions. One or more of the spotlights 52 can flash on and off, in the manner of strobe lights. Power cords 64 extend from the housings 54 to the battery pack 66. The stub power cord 68 extends from the battery pack 66 to the recharging socket 70.

The battery pack 66 includes the housing 72 affixed to the upper housing half 240, which contains the rechargeable batteries 74. The lead wires 90 and 92 of the power cords 64 of the spotlights 52 extend through the insulating sheath 94 into the housing 72 connected as stated above. The push-button 100 of switch 96 is engaged by an inner end 266 of a push rod 268 slidably disposed through the switch actuating tube 254 of the upper housing half 240 with a finger-actuatable outer end 270 that extends radially inwardly. The inner end 266 of push rod 268 is of enlarged diameter to prevent inadvertent removal from housing 238. The O-ring 109 is disposed in an external O-ring groove 272 of push rod 268, to prevent water from entering the housing 238. The switch 96 allows charging of the batteries 74 without the spotlights 52 being illuminated. The lead wires 112 and 114 of the stub power cord 68 extend through the insulating sheath 116 into the housing 72, and are connected as stated above.

The body 118 of the recharging socket 70 threads into the electrical socket hole 250 of the outer side wall 252 of upper housing half 240. The lead wires 112 and 114 of the stub power cord 68 are connected to the recharging socket 70, as explained above. The resilient gasket 128 is affixed to the outer side wall 252 of the upper housing half 240 and the socket 70, to provide a waterproof seal therebetween.

The sealing plug 132 includes the head 134 and dependent stem 136 which closely frictionally fits within the central bore 120 of the socket 70 during water use, to prevent water from shorting between the electrical contacts 124 and 126.

The recharging device 16 includes the recharging plug 138 for connecting to the recharging socket 70, the main power cord 162, and the wall plug 168 for plugging into the electrical outlet.

The light ring 236 floats on the swimming pool 198, or the body of water 82 alongside the boat 182, illuminating downwardly in a circular or cone-shaped pattern. The light ring 236 may be tied-off from the boat 182 on the body of water 82, using the eye bolt 176 or the U-bolt 214, the chain 178, and the clip 180 from the tie-off 184 as explained above. Weights (not shown) can be placed below the lower housing half 208, for balance.

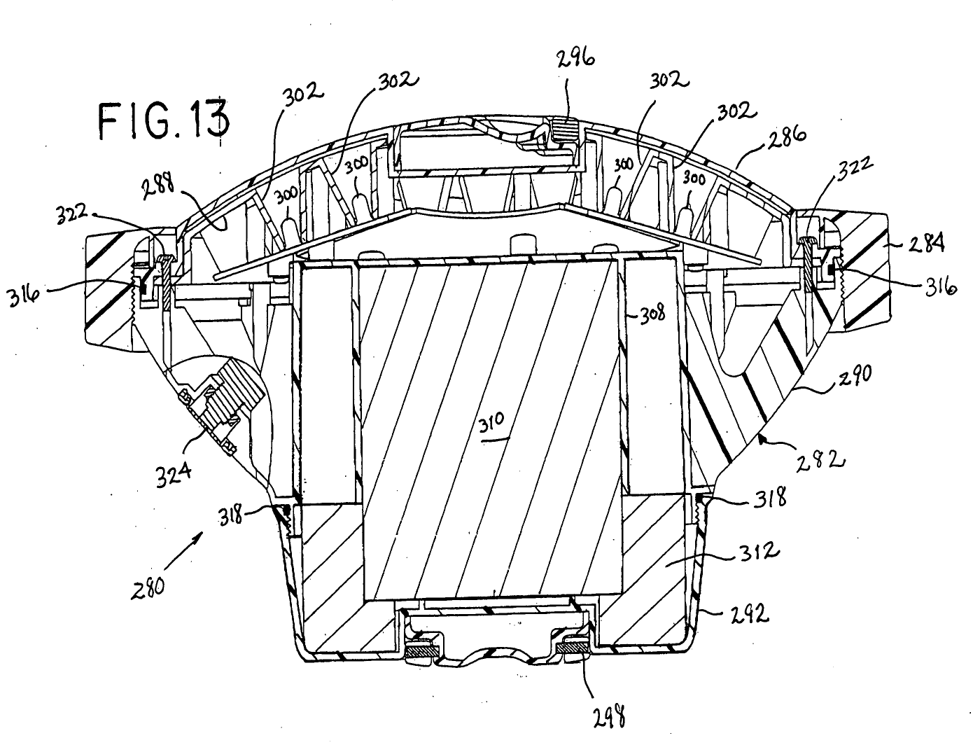

FIGS. 12-13 show a fourth, and the most preferred, embodiment of the invention. The submersible lighting fixture or device 280 is shown in an exploded view in FIG. 12, and in an assembled, cross-sectional view in FIG. 13.

The submersible device 280 includes a substantially water-tight enclosure 282. In this preferred embodiment, this enclosure 282 includes a number of major components, and a number of elements contained within that enclosure 282.

The major components of the enclosure include a lens ring 284, a generally clear lens 286, a generally hemispherical dome 288, a housing 290, and a lower cover 292.

In this preferred embodiment, the lens ring 284 is a generally opaque element, preferably made of an opaque polycarbonate. The interior of the lens ring 284 includes an internally threaded portion 294. This internally threaded portion 294 of the lens ring 284 is threaded onto a complementarily threaded portion 296 of the housing 290. It is preferable that the lens ring 284 is of a bright color, such as yellow, so that the submersed device 280 can be easily seen by the user.

The lens 286 is also made of a polycarbonate material. In this case, however, the polycarbonate material is preferably transparent. In this way, the light emitted from the lighting elements, and positioned below the lens 286, can shine through that lens 286.

Polycarbonate or any other suitable hard plastic is also the preferred material for a first eyelet or light holder 296. This first eyelet 296 is positioned at the top of the enclosure 282. The first eyelet 296 is pivotable approximately 90 degrees about its base.

In one of its positions, i.e., the flattened position of both FIGS. 12 and 13, the first eyelet 296 is substantially flush, and positioned closely against the top surface of the lens 286 of the enclosure 282.

In the second of its positions, i.e., pivoted 90 degrees from its flattened position of FIGS. 12 and 13, the first eyelet 296 is raised into a vertical position, i.e., into a position coincident with a vertical plane. In this vertical position, the first eyelet 296 may be engaged by a rope (not shown). The rope may be secured to this eyelet 296, and then used by the operator, to control the position of the submersible device 280. Alternatively, the rope may permit the submersible device 280 to be raised or lowered by the operator within the pool, lake, ocean, or other body of water.

A second eyelet or light holder 298 is positioned at the bottom of the enclosure 282. Like the first eyelet 296, this second eyelet 298 pivots about 90 degrees from its flattened position of FIGS. 12 and 13. When this second eyelet 298 is pivoted about 90 degrees from the flattened position, it can similarly be engaged with a rope, for the same purposes, and to the same effect, as the attachment of the rope to the first eyelet 296.

Referring now again to FIG. 12, and as noted above, positioned below the lens 286 is a generally hemispherical dome 288. This dome 288 is made of a suitable hard plastic, such as acrylonitrile butadiene styrene (hereinafter referred to as “ABS”).

This dome 288 acts as a reflector of the light emitted by the lighting elements of the submersible device 280. In order for the dome 288 to act as a reflector, the ABS dome is preferably plated with a metal. While any suitable metal may be used, the most preferred metal with which to plate the ABS of this dome 288 is chromium.

Light emitting diodes 300 (LEDs) are positioned within the hemispherical dome 288. A plurality of such light emitting diodes 300 are provided. In this case, “plurality” means anywhere from two LEDs, to up to five thousand (5,000) or more LEDs. Particularly, each of the LEDs 300 are positioned within complementary cone-shaped orifices 302 that are a part of, and integrally formed within, the hemispherical dome 288.

As may best be seen in the cross-sectional view of FIG. 13, the walls of housing 290 have a generally curved shape. Nevertheless, this housing 290 can be generally described as having the shape of a frustum of a cone, i.e., a truncated portion of a cone.

The top of the housing 290 has an externally threaded portion 304. This externally threaded portion 304 is complementary to the internally threaded portion 294 of the lens ring 284. In this way, the lens ring 284 and the top of the housing 290 can be secured to each other.

In addition, as can best be seen in FIG. 13, the bottom of the housing 290 also has an externally threaded portion 306.

As may also be seen in FIG. 12, the housing 290 has a generally box-shaped compartment 308. This compartment 308 is of a shape and volume adequate to house one or more rechargeable batteries 310.

As may be seen in FIG. 12, a removable weight 312 may be contained within the enclosure 282. This removable weight 312 may optionally be inserted into the enclosure 282, if such insertion is necessary to overcome the natural buoyancy of the submersible device, so as to ensure the efficient and prompt sinking of the submersible device 280 into a particular body of water.

As may best be seen in FIG. 12, the removable weight 312 may be made into an irregular shape. Because of its irregular shape, the removable weight 312 will fit closely around the perimeter of the battery 310, and will also fit closely to the inner walls of the housing 290. Because of its irregular shape, the removable weight 312 can fit efficiently into the existing contours of the housing 290.

Lower cover or battery cover 292 has a generally cylindrical shape, and is also preferably made of a polycarbonate material. Internal threads 314 are complementary to, and mate with, the externally threaded portion 306 of the housing 290.

All of the threaded connections help to create the substantially water-tight enclosure 282. Other elements that help to create this substantially water-tight enclosure 282 include a first gasket 316 positioned between the lens 286 and the generally hemispherical dome 288; a second gasket 318 disposed between the lower cover 292 and the housing 290; and a plurality of screws 322 that tightly secure lens 286, first gasket 316, generally horizontal dome 288, and housing 290.

The submersible lighting device 280 includes a generally flat bottom 320. This flat bottom 320 is positioned at the lower cover 292 or battery cover 292. The flat bottom 320 permits the submersible device 280 to sit upright on the floor of a pool or pond. In this way, the submersible device 280 is ideally configured to project light in a desired pattern and in a desired manner.

Particularly, when this submersible device 280 is in its upright position at the bottom of a body of water, its light elements or LEDs 300 are positioned on the dome 288 such that at least some of the lighting elements 300 are upwardly disposed from the submersible lighting device 280, at an angle from the vertical.

In other words, the lighting elements 300 project light upwardly so as to collectively create a cone-shaped pool of light, extending from the top of the enclosure 282 to the surface of the body of water. Ideally, the angle of the lighting elements 300 is such that when the submersible device 280 is positioned on a rope or tether at a distance of: (a) five (5) feet below the surface of water, the cone has a largest (or upper) diameter of five (5) feet; (b) ten (10) feet below the surface of water, the cone has an upper diameter of ten (10) feet; and (c) fifteen (15) feet below the surface of water, the cone has an upper diameter of fifteen (15) feet.

As may be seen in FIG. 13, the axis of the lighting elements 300 is preferably offset, from the vertical, at an angle of 20 to 30 degrees. The range of angles of the axis of the lighting elements, from the vertical, is from about 1 degree to about 45 degrees.

As alluded to above, the construction of this device 280 permits the creation of a cone-shaped region of light, disposed between the top of the device 280 and the surface of the water.

As noted above, the battery 310 or batteries are of a rechargeable type, and include a pair of battery connectors 326. Any generally suitable rechargeable battery can be used. A most preferred battery 310 is a twelve-volt (12 V.), 5000 μA rechargeable battery, such as Radio Shack battery Model 23-289. The battery 310 can include a charging inlet (not shown), for permitting the insertion of a power cable, to permit recharging of the batteries.

The device 280 includes a waterproof switch 324. Depressing the waterproof switch 324 powers the LEDs 300. Pressing the switch 324 a second time disconnects power from the LEDs.

Alternatively, a multi-position waterproof switch may be provided. This multi-position waterproof switch has different positions which may, as but a few examples, (a) enable the device 280 to be turned “off” (b) enable the device to be turned “on”; (c) enable the device 280 to be turned to a position where the LEDs 300 flash sequentially “on” and “off”, at a predetermined frequency; and (d) enable the device 280 to flash the universal “SOS” distress signal.

In addition, the device 280 includes a feature which determines the charge, i.e., the power status, of the battery 310. When the battery 310 is in a weakened, discharged state, and ready for recharging, the control circuitry causes the LEDs to flash. This flashing acts as a signal that the battery 310 needs to be recharged.

Regardless of the switch that is to be used, electrical current passes from the battery 310 through the battery connectors 326, and on to the printed circuit boards 328 and the LEDs 300.

As suggested above, rather than permitting the device 280 to rest upon a pool bottom or lake bottom, the user may attach the first eyelet 296 to a fifteen (15) foot depth rope (not shown).

This depth rope may include four metal swivel snap hooks. Two of the swivel snap hooks are located at the distal ends of the depth rope. The other two swivel snap hooks are located five (5) feet from the opposite distal ends of the depth rope. As a result, the swivel snap hooks are located at one end of the depth rope, and at intervals of every five (5) feet from the end of the depth rope.

The first swivel snap hook, at one end of the depth rope, can be attached to a float. The rest of the depth rope extends downwardly, into the body of water, so that the second hook is five feet below the surface of the water, the third hook is ten feet below the surface of the water, and the fourth hook is fifteen feet below the surface of the water.

The float can be positioned at a location perhaps twenty feet behind the stern of the boat, by means of a boat tether. One end of the boat tether is secured to the boat, while the other end of the boat tether is secured to the float.

The float is preferably an inflatable ring. An air inflation valve is provided on the upper surface of the ring. Air inflates both the outer ring of the float, and five internal, inflatable spokes on the top and the bottom of the float. These inflatable spokes also provide additional structural support for the float. Finally, the spokes add extra strength to float, to aid in supporting the weight of the submersible lighting device 280.

The float is preferably made of a flexible polymeric or natural fabric. Overlapping portions of those fabrics that are used to make the float may be secured to each other by means of heat sealing.

It may be desirable to leave the device 280 at a remote location, for extended periods of time. For example, in connection with Coast Guard or other military training, it may be desirable to semi-permanently secure the device 280 to a lake bed. At night, the device 280 could be turned to the “on” position, so as to illuminate the water in the lake in the region where soldiers will be practicing water jumps, from a helicopter or other similar aircraft.

In order to semi-permanently secure the device 280 to the lake bed, a heavy anchor (not shown) can be secured to the second eyelet 298. To prevent the device 280 from moving laterally within the lake, a rope can be used to secure the bottom of the float (described above) to the first eyelet 296.

While specific embodiments have been illustrated and described, numerous modifications come to mind without significantly departing from the spirit of the invention and the scope of protection is only limited by the scope of the accompanying Claims.

What is claimed is:

1. A submersible lighting device, comprising: (a) a substantially water-tight enclosure; and; (b) a plurality of lighting elements at the top of that enclosure, wherein a beam of light projecting from at least some of the lighting elements is upwardly disposed from that lighting device at an angle from the vertical.

2. The submersible lighting device of claim 1, further comprising a removable weight disposed within the substantially water-tight enclosure.

3. The submersible lighting device of claim 1, further comprising a battery.

4. The submersible lighting device of claim 3, wherein the battery is rechargeable.

5. The submersible lighting device of claim 1, wherein the lighting elements are light-emitting diodes.

6. The submersible lighting device of claim 1, wherein the lighting elements are contained within a generally hemispherical dome.

7. The submersible lighting device of claim 1, wherein the substantially water-tight enclosure includes a generally flat bottom.

8. The submersible lighting device of claim 1, further comprising a first eyelet at the top of the enclosure.

9. The submersible lighting device of claim 1, further comprising a second eyelet at the bottom of the enclosure.

10. The submersible lighting device of claim 8, further comprising a second eyelet at the bottom of the enclosure.

11. The submersible lighting device of claim 1, further comprising a lens ring covering the generally hemispherical dome.
